(19) United States
(12) Patent Application Publication
(10) Pub. No.: US 2022/0073384 A1
(43) Pub. Date: Mar. 10, 2022

(54) WATER MAGNETIZING DEVICE

(71) Applicant: DOUBLEU WATER, Anyang-si (KR)

(72) Inventor: Man Kee BYUN, Gunpo-si (KR)

(21) Appl. No.: 17/312,991

(22) PCT Filed: Dec. 12, 2019
(86) PCT No.: PCT/KR2019/017577

§ 371 Date: Jun. 11, 2021

(30) Foreign Application Priority Data
Dec. 13, 2018 (KR) 10-2018-0161067

(51) Int. Cl. C02F 1/48

(52) U.S. Cl. CPC C02F 1/482; C02F 2201/48; C02F 2201/002; C02F 2301/026

(57) ABSTRACT

The present invention relates to a water magnetizing device which is installed on a water pipe so as to atomize inflowing water and discharge same, and more specifically, to a water magnetizing device which maximizes the performance of the atomization, by means of a magnetic field, of water passing through a magnetic field region inside a water activation pipe, and enables the water to be discharged by having torque applied to the water by a rotational pressurization part provided inside the water activation pipe, thereby enabling the long-distance transport of the discharged nano water.

### FIELD OF THE INVENTION

The present disclosure relates to a water magnetizing device which is installed in a water pipe so as to atomize inflowing water and discharge same, and more specifically, to a water magnetizing device which maximizes the performance of the atomization of water, delays the reduction of discharged water in the water pipe, and enabling the atomized water to transport to a longer distance.

### BACKGROUND OF THE INVENTION

In general, water is a combination of two hydrogen atoms and one oxygen atom. As the temperature increases, water has a chain form or a pentagonal ring form composed of five water molecules, and as the temperature decreases, hexagonal water having a hexagonal ring-shaped molecular structure is produced.

At this time, it is known that the hexagonal water can be produced by cooling water and lowering the temperature, and the hexagonal water produced has a large heat capacity and matches with other biomolecules, thus improving the vital functions of living organisms.

However, the method of producing a hexagonal water by cooling water has a large energy loss and is not used because the effect of producing hexagonal water is insufficient. Accordingly, conventionally, as disclosed in Korean Patent No. 10-0790340 (registered on Dec. 24, 2007, entitled “water magnetizing device”), a water magnetizing device, in which cluster particles of water are automized while passing water into the magnetic field region generated by a permanent magnet, thereby increasing the dissolved oxygen in water, is widely used for drinking water, agricultural water, tap water, and the like.

However, a conventional water magnetizing device has limitations that immediately after the water atomized through the internal magnetic field region is drained by a connected water pipe, it is rapidly reduced, agglomerated together and returned to an original particle size. Therefore, there was a limitation in that the atomized water is discharged, making it difficult to transport over a long distance through water pipes.

More specifically, with respect to a stationary magnetic fluid placed in the horizontal direction, the fluid, that flows inside the magnetic field region formed between a pair of facing magnets in response to changes in the internal flow velocity, undergoes an eddy phenomenon that flows along the direction in which the magnetic field is induced. At this time, due to the eddy phenomenon in each magnetic field region, the water passing through the magnetic field collides with each other to cause atomization. However, as the flow velocity of the inflowing fluid increases, there is a limitation in that the effect of the magnetic field on the fluid in the pipe is reduced.

In other words, in order to suppress the reduction of the magnetic water magnetized through the magnetic field, the flow velocity of the discharged magnetic water must be increased. And, in the case of a water magnetizing device that is not equipped with a drive device such as a separate motor, it is necessary to increase the flow velocity of the inflowing water, but as the velocity of water passing through the magnetic field region increases, a problem arises that the effect of the magnetic field on water is reduced.

### SUMMARY OF THE INVENTION

### Technical Problem

Therefore, the present disclosure has been designed to solve the above-mentioned problems, and it is an object of the present disclosure to provide a water magnetizing device which maximizes the performance of the atomization of water, suppresses the reduction of atomized water, and enables the long-distance transport of the discharged nano water.

### Technical Solution

In order to achieve the above object, the present disclosure provides a water magnetizing device which is installed in a water pipe and which atomizes and discharges water flowing into a magnetic field region formed inside, the water magnetizing device comprising: a water activation pipe that forms a water channel through which water flows inside and includes a water intake unit through which water flows into one side of the axial direction, and a drainage unit through which water flows into the other side and atomized water is discharged, and a magnetizing unit in which the magnetic material is arranged on an outer peripheral surface and a magnetic field region is formed therein; a housing formed so as to surround the outer surface of the water activation pipe; a magnetic material which is interposed between the water activation pipe and the housing and which includes a plurality of permanent magnets arranged so as to surround the outer peripheral surface of the magnetizing unit of the water activation pipe and a plurality of shielding members provided between the plurality of permanent magnets; and a rotary pressure unit including a shaft fixed in the axial direction therein and a rotation induction blade formed spirally along the outer peripheral surface of the shaft, wherein the water activation pipe is divided into a water intake unit, a magnetizing unit having the magnetic field region, and a drainage unit having the rotary pressure unit in the travelling direction of water, and the rotary induction blade of the rotary pressure unit is formed so that the blade length corresponds to the inner peripheral surface of the water activation pipe, water passes through the magnetic field region formed inside the magnetizing unit by the magnetic material, atomized water flows along the rotation induction blades to the rotary pressure unit of the drainage unit, so that the water is discharged by having torque applied, and automized water is discharged so as to have a single rotation flow while maintaining a compressive force, thereby suppressing the reduction of the water transferred after being discharged, the atomized water can be transported over a long distance.

### Advantageous Effects

The present disclosure based on the above-mentioned configurations has advantages that water atomized by the internal magnetic field region is discharged by having torque applied by the rotary pressure unit provided inside the water activation pipe, so that the reduction of atomized water is suppressed by the torque applied to the discharged water, thus being able to transport atomized water over a longer distance.

In addition, the present invention has the features that by inducing turbulence of water passing through the magnetic field region inside the water activation pipe, it maximizes the atomization performance of water by the magnetic field and, at the same time, it has a structure that can maximize the torque of the discharged water.

### BRIEF DESCRIPTION OF THE DRAWINGS

FIG. 1 is a perspective view showing a water magnetizing device according to an embodiment of the present disclosure;

FIG. 2 is a cross-sectional view showing a water magnetizing device according to a first embodiment of the present disclosure;

FIG. 3 is a cross-sectional view showing a water magnetizing device according to a second embodiment of the present disclosure;

FIG. 4 is a perspective view showing a water activation pipe according to a third embodiment of the present disclosure;

FIGS. 5 and 6 are cross-sectional views showing a water activation pipe of the present disclosure;

FIGS. 7 and 8 are cross-sectional views showing a water magnetizing device according to a fourth embodiment of the present disclosure; and

FIGS. 9 and 10 are cross-sectional views showing a water magnetizing device according to a fifth embodiment of the present disclosure.

### DETAILED DESCRIPTION OF THE EMBODIMENTS

In order to achieve that above object, the present disclosure relates to a water magnetizing device which is installed in a water pipe and which atomizes and discharges the water flowing into the magnetic field region formed therein, and more particularly, to a water magnetizing device comprising: a water activation pipe that forms a water channel through which water flows inside and includes a water intake unit through which water flows into one side of the axial direction, and a drainage unit through which water flows into the other side and atomized water is discharged; a housing formed so as to surround the outer surface of the water activation pipe; a magnetic material which is interposed between the water activation pipe and the housing and which includes a plurality of permanent magnets arranged so as to surround the outer peripheral surface of the water activation pipe and a plurality of shielding members provided between the plurality of permanent magnets; and a rotary pressure unit including a shaft fixed in the axial direction inside the water activation pipe and a rotation induction blade formed spirally along the outer peripheral surface of the shaft, wherein water passes through the magnetic field formed inside the water activation pipe by the magnetic material, and atomized water flows along the rotation induction blade of the rotary pressure unit, so that the water is discharged by having torque applied.

Also, the magnetic material is arranged such that the plurality of permanent magnets and the plurality of shielding members alternate with each other in the axial direction of the water activation pipe, and the permanent magnets facing each other in the radial direction are arranged so as to have the same polarity.

In addition, the magnetic material is arranged such that the plurality of permanent magnets and the plurality of shielding members alternate with each other along an outer peripheral surface of the water activation pipe in a radial direction of the water activation pipe.

Moreover, the water activation pipe is formed so that the inner diameter of the drainage unit becomes gradually smaller toward the outside in the axial direction, thereby increasing the torque of the discharged water.

Further, the water activation pipe may further comprise a rotation induction projection formed so as to spirally protrude along the axial direction on the inner peripheral surface.

At this time, the water activation pipe further comprises a magnetizing unit in which the magnetic material is arranged on an outer peripheral surface and a magnetic field region is formed therein, the rotation induction projection formed in the magnetizing unit of the water activation pipe is divided in the axial direction and formed so as to have a plurality of patterns, and the plurality of the divided rotation induction projections have different patterns from other adjacent rotation induction projections.

Further, the water activation pipe further comprises a magnetizing unit in which the magnetic material is arranged on an outer peripheral surface to form a magnetic field region therein, the magnetizing unit of the water activation pipe forms a plurality of partition walls projecting radially from the inner surface, the plurality of partition walls being formed so that the inner surfaces in contact with another adjacent partition wall in the axial direction face each other, and the partition wall is formed so that a surface in contact with the inner surface of the water activation pipe corresponds to a position where the shielding member of the magnetic material is provided.

Further, the rotary pressure unit is provided over the entire area in the axial direction of the water activation pipe, the magnetic material comprises: an external magnetic material comprising a plurality of first permanent magnets arranged so as to surround the outer peripheral surface of the water activation pipe, and a plurality of shielding members provided between the plurality of first permanent magnets; and an internal magnetic material comprising a second permanent magnet arranged so as to surround an inner peripheral surface of the shaft of the rotary pressure unit, and is provided at a position corresponding to the plurality of first permanent magnets, and a second shielding member provided between the plurality of second permanent magnets.

At this time, the second shielding member of the internal magnetic material further comprises a plurality of terminal shielding members provided between the plurality of second permanent magnets arranged in the axial direction; and a crossing shielding member provided so as to surround the inner peripheral surface of the plurality of second permanent magnets.

Further, the magnetic material further comprises a plurality of third permanent magnets arranged along the outer surface of the induction blade of the rotary pressing unit, and a third shielding member provided between the plurality of third permanent magnets.

The invention disclosed herein can be modified in various forms and can have various embodiments. Specific embodiments thereof will be illustrated in the drawings and described in detail.

However, the embodiments are not intended to limit the invention, but it should be understood that the invention includes all modifications, equivalents, and replacements falling within the spirit and scope of the invention.

When a component is described as “connected” or “joined” to another component, it is to be appreciated that the two components can be directly connected or directly joined to each other but can also include one or more other components in-between.

If it is not contrarily defined, all terms used herein including technological or scientific terms have the same meanings as those generally understood by a person with ordinary skill in the art.

Terms defined in generally used dictionary shall be construed that they have meanings matching those in the context of a related art, and shall not be construed in ideal or excessively formal meanings unless they are clearly defined in the present application.

Hereinafter, embodiments of the invention will be described in detail with reference to the accompanying drawings.

Since the accompanying drawings are only an example shown in order to explain the technical idea of the present disclosure more detail, the technical spirit of the present disclosure is not limited to the form of the accompanying drawings.

<First Embodiment>

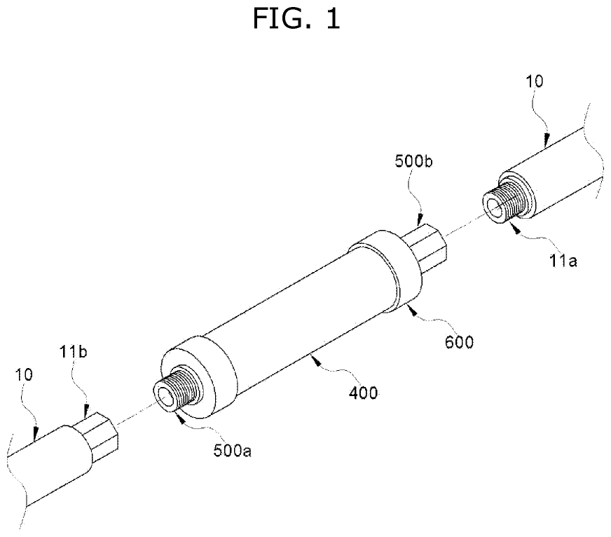

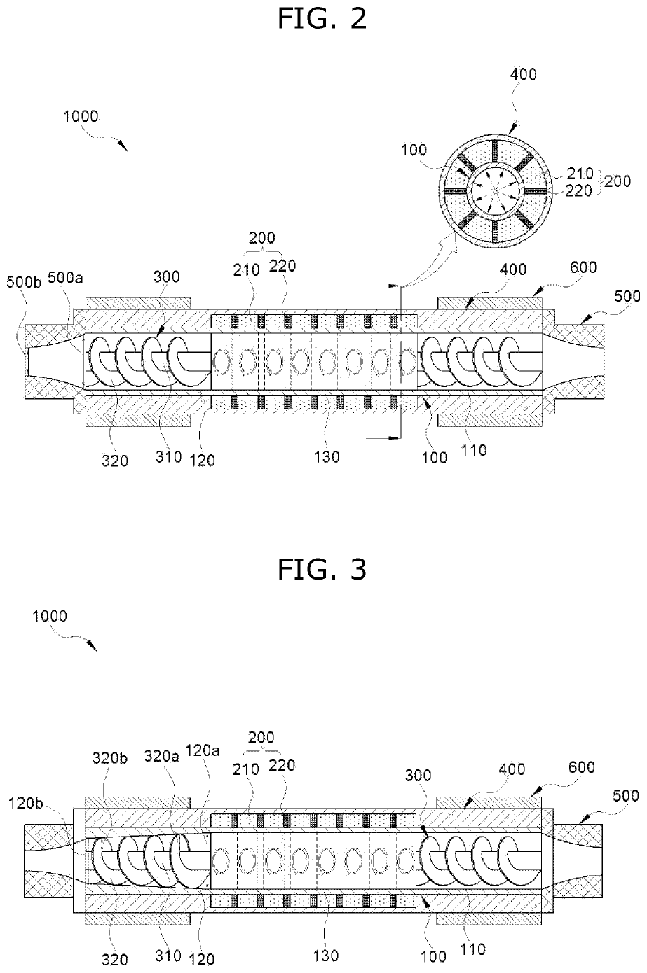

FIG. 1 is a perspective view showing a water magnetizing device according to an embodiment of the present disclosure, and FIG. 2 is a cross-sectional view showing a water magnetizing device according to a first embodiment of the present disclosure. Referring to FIGS. 1 and 2, the water magnetizing device 1000 according to an embodiment of the present disclosure may comprise a water activation pipe 100, a magnetic material 200, a rotary pressure unit 300, a housing 400, a connection unit 500 and a protective cap 600.

The water activation pipe 100 forms a water channel through which water flows therein, and has a configuration in which a magnetic material 200 is disposed on the outside to atomize inflowing water and discharge it. The water activation pipe 100 may comprise a water intake unit 110 through which water flows on one side in the axial direction, a drainage unit 120 in which atomized water that flows into the other side is discharged, and a magnetizing unit 130 having a magnetic field region formed by the magnetic material 200 in the center in the axial direction.

At this time, the housing 400 is formed so as to surround the outer surface of the water activation pipe 100, and has a configuration for housing the water activation pipe 100 and the magnetic material 200 therein, wherein a connection unit 500 for connecting with a water pipe 10 may be formed at both side ends in the axial direction, and the connection unit 500 is preferably configured so as to have a shape or form that can be coupled in correspondence to the water pipe connecting unit 11 formed at one end of the water pipe 10. In the drawings of the present disclosure, the shape of the connection unit 500 is shown as a shape having a male screw having a thread formed along the outer peripheral surface, or a female screw having a thread formed along the inner peripheral surface, but modifications can be made using various fastening means without departing from the gist of the present disclosure.

In addition, the housing 400 may be configured in combination with a protective cap 600 formed so as to surround a portion of the outer peripheral surface. The protective cap 600 is made of a rubber material having a certain thickness, and is coupled to both side ends of the housing 400 to form a pair, so that it is preferably coupled so as to protect the housing 400 from external impact.

The magnetic material 200 is interposed between the water activation pipe 100 and the housing 400, and comprises a plurality of permanent magnets 210 disposed so as to surround the outer peripheral surface of the water activation pipe 100 and a plurality of shielding members 220 provided between the plurality of permanent magnets 210. The permanent magnet 210 has magnetic regions in different directions and is offset as a whole, but does not show magnetism. However, once magnetized, it is a magnet with the property of permanently preserving magnetism, and various modifications such as chrome steel or ferrite magnet can be made without departing from the gist of the present disclosure. In addition, the shielding member 220 is coated with a non-conductor on the outer surface of the metal to shield the magnetic fields from interfering between the plurality of arranged permanent magnets 210. When a plurality of permanent magnets 210 arranged so as to face each other in the radial direction are arranged in the axial direction, a magnetic field region partitioned into a plurality in the axial direction may be formed by being provided between the plurality of permanent magnets 210 in the axial direction.

At this time, the magnetic material 200 is arranged at regular intervals so that the plurality of permanent magnets 210 and the plurality of shielding members 220 alternate with each other in the axial direction of the water activation pipe 100, wherein the permanent magnets 210 facing each other in the radial direction are arranged so as to have the same polarity. Thereby, each independent magnetic field region is partitioned between a pair of permanent magnets 210 facing each other in the radial direction, and the adjacent flow of each partitioned magnetic field is induced by magnetic fields traveling in different directions, so that water in the adjacent magnetic field region collides with each other and becomes atomized, thereby making it possible to further enhance the performance of the atomization of water passing through the water activation pipe 100 by the magnetic field. At this time, the intensity of the magnetic force of the permanent magnet 210 is determined depending on the inner diameter of the water activation pipe 100 and the flow velocity of water flowing in the inside of the water activation pipe 100. Preferably, a magnetic force of 800 to 1200G [gauss] should be formed, wherein the water atomized through the magnetic field region (hereinafter, referred to as nano water) is atomized into cluster particles having a nano size of 1.2 nm to 0.4 nm.

In addition, the magnetic material 200 may be formed such that the plurality of permanent magnets 210 and the shielding member 220 alternate with each other along the outer peripheral surface of the water activation pipe 100 in the radial direction of the water activation pipe 100. At this time, the magnetic material 200 forms a plurality of magnetic field regions partitioned in the radial direction, so that eddy flow by the plurality of magnetic field regions formed in the radial direction interferes with each other, thereby increasing the complexity of the flow, and reducing the flow velocity in the magnetic field region.

The rotary pressure unit 300 comprises a shaft 310 fixed in the axial direction to the inside of the water activation pipe 100 and a rotation induction blade 320 formed spirally along the outer peripheral surface of the shaft 310. Water passes through the magnetic field formed inside the water activation pipe 100 by the magnetic material 200, and automized water flows along the rotation induction blade 320 of the rotary pressure unit 300, thereby having torque applied and discharged. Therefore, the flow velocity lowered in the magnetic field region is compensated by the torque applied to the discharged water. When discharged and transferred inside the water pipe 10, the nano water discharged has a torque, and thus, it has the effect that the atomized water can be sustained without being reduced over a long distance.

More specifically, the rotation induction blade 320 of the rotary pressure unit 300 is formed so that the blade length corresponds to the inner peripheral surface of the water activation pipe 100. Water passes through the magnetic field region formed inside the magnetizing unit 130 by the magnetic material 200, and the atomized water flows along the rotation induction blade 320 to the rotary pressure unit 300 of the drainage unit 120, and can be discharged by the application of torque. At this time, the rotation induction blade 320 is made such that the radially outer end is in contact with the inner surface of the water activation pipe 100, and most preferably, water flows along the outer surface of the rotation induction blade 320. However, without departing from the gist of the present disclosure, it may be formed so as to be adjacent to each other while forming a gap for coupling of the rotary pressure unit 300

<Second Embodiment>

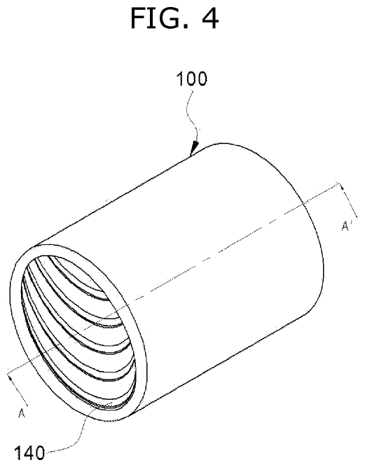

FIG. 3 is a cross-sectional view showing a water magnetizing device according to a second embodiment of the present disclosure.

Referring to FIG. 3, the water magnetizing device 1000 according to the second embodiment of the present disclosure is formed so that the inner diameter of the drainage part 120 of the water activation pipe 100 becomes gradually smaller toward the outside in the axial direction, and the inner diameter of the drainage unit 120 of the water activation pipe 100 is formed to gradually decrease toward the outside in the axial direction and discharged, thereby being formed so as to further increase the torque of water.

At this time, the rotation induction blade 320 of the rotary pressure unit 300 is formed to correspond to the reduced inner diameter of the drainage unit 120 so that the blade length is gradually reduced. As the water flowing along the rotation induction blade 320 is gradually compressed toward the outside in the axial direction, the discharge velocity of the discharged nano water is increased, and the discharged nano water can be transferred to a longer distance without its reduction.

Further, the connection unit 500, that is formed at both ends in the axial direction of the water activation pipe 100 and is coupled to the water pipe, is formed in an orifice shape whose inner diameter gradually decreases toward the outside in the axial direction, thereby reducing the flow velocity of water flowing into the water pipe 100, whereas the diameter of the discharge port is preferably reduced to increase the flow velocity of the discharged water. At this time, the inner diameter at the outer end of the axial direction of the connection unit 500 is made of the same diameter as the inner diameter of the connected water pipe, and the inner diameter of the water activation pipe 100 is preferably larger than the inner diameter of the water pipe.

<Third Embodiment>

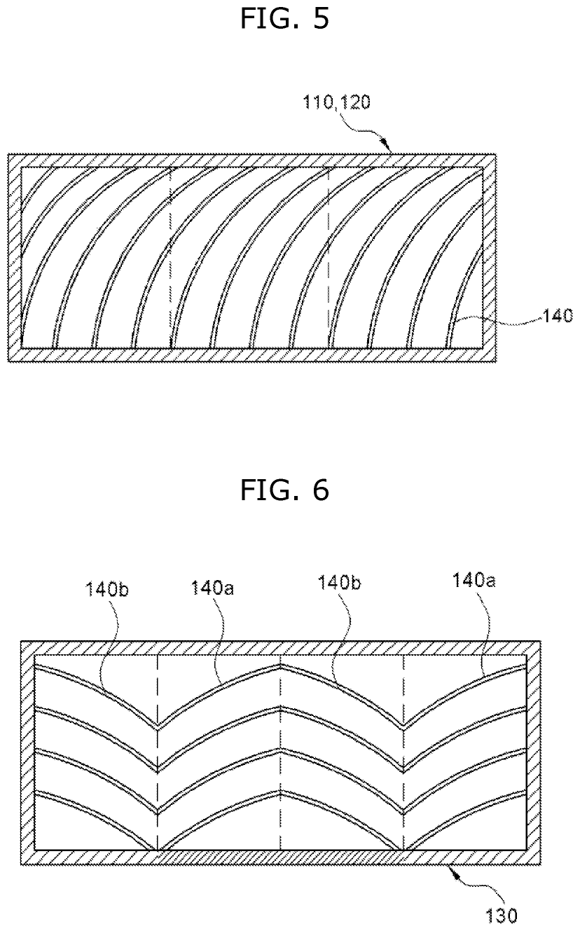

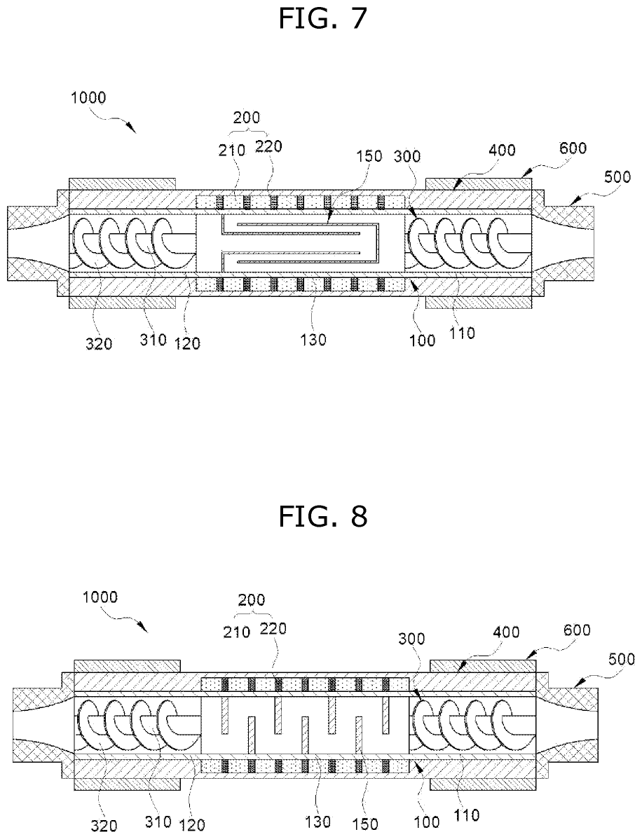

FIG. 4 is a perspective view showing a water activation pipe according to a third embodiment of the present disclosure, FIG. 5 is a cross-sectional view taken along line A-A′ of FIG. 4, and FIG. 6 is a view showing a modified embodiment of the rotation guiding projection 140 according to FIG. 5. Referring to FIGS. 4 to 6, the water magnetizing device 1000 according to the third embodiment of the present disclosure is configured such that a rotation guiding projection 140 formed so as to protrude spirally along the axial direction is formed on the inner peripheral surface of the water activation pipe 100, and the water flowing along the inner peripheral surface of the water activation pipe 100 is induced to have torque by the rotation induction protrusion 140, thereby further increasing the torque in the rotary pressure unit 300.

At this time, the rotation induction projection 140 formed on the magnetizing unit 130 of the water activation pipe 100 is divided in the axial direction to have a plurality of patterns. The divided plurality of rotation induction projections 140a are formed to have different patterns from other adjacent rotation induction projections 140b, thereby increasing the complexity of the flow of water passing through the magnetic field inside the magnetizing unit 130 to form turbulence and thus reducing the flow velocity passing through the magnetic field region, and finally increasing the atomization performance of water in the magnetic material 200.

That is, the magnetizing unit 130 of the water activation pipe 100 is formed with a rotation induction protrusion 140 having different patterns, thereby reducing the flow velocity. In the section of the drainage unit 120 passing through the magnetizing unit 130, the rotation induction projection 140 is formed so as to correspond to the rotation induction blade 320 of the rotary pressure unit 300, so that the rotation flow of water passing through the drain unit 120 is proceeded more smoothly, thereby increasing the rotation force of the nano water passing through the drainage unit 120, increasing the discharged flow velocity, so that the discharged nano water can be transferred over a long distance without its reduction.

<Fourth Embodiment>

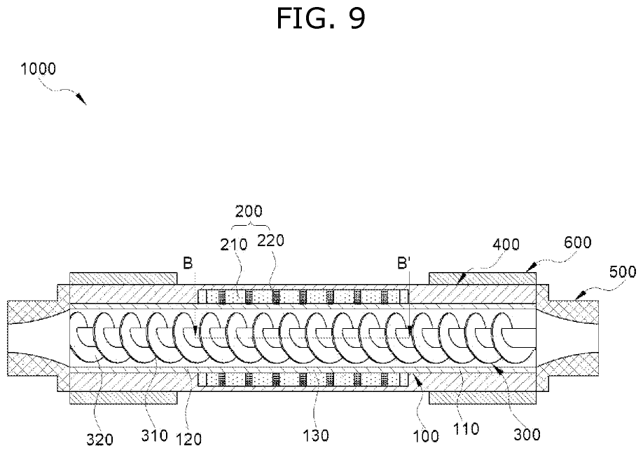

FIGS. 7 and 8 are cross-sectional views showing a water magnetizing device according to a fourth embodiment of the present disclosure. Referring to FIGS. 7 and 8, the water magnetizing device 1000 according to the fourth embodiment of the present disclosure may further comprise a partition wall 150 formed in the magnetizing unit 130 of the water activation pipe 100.

The partition wall 150 is configured to increase the performance of water atomization by increasing the traveling path of water passing through the magnetic field region, and a plurality of partition walls partitioned in the axial direction as shown in FIG. 7 may be installed to guide the traveling path of water. At this time, the method as shown in FIG. 7 has the effect of increasing the path along which water travels and allowing the passing water to stay in the magnetic field region for a longer period of time, but there being a limitation in that water passes without increasing the residence time in a single magnetic field region partitioned by the permanent magnets 210 facing each other in the radial direction. Therefore, in the present disclosure, the partition wall 150 is formed so as to protrude from the inner surface of the magnetizing unit 130 in a radial direction, and is arranged in a plurality of walls in the axial direction, wherein the plurality of partition walls 150 are arranged so that inner surfaces of the plurality of partition walls 150 in contact with the other partition wall 150 adjacent in the exit direction face each other. As the water flown into the magnetizing unit 130 is rotated and flowed along the outer surface of the water activation pipe 100 by the partition wall 150, so that the torque of the water applied by the rotation induction protrusion 300 in the water intake unit 110 can be preserved as much as possible to transmit to the drainage unit 120.

In addition, the partition wall 150 is formed so that the surface in contact with the inner surface of the water activation pipe 100 corresponds to the position where the shielding member 220 of the magnetic material 200 is provided. And, it is arranged so as to partition the magnetic field region partitioned by the magnetic body 200 at all times in the axial direction, so that it has an effect of increasing the residence time in each magnetic field region and, at the same time, preserving the torque of the flowing water.

<Fifth Embodiment>

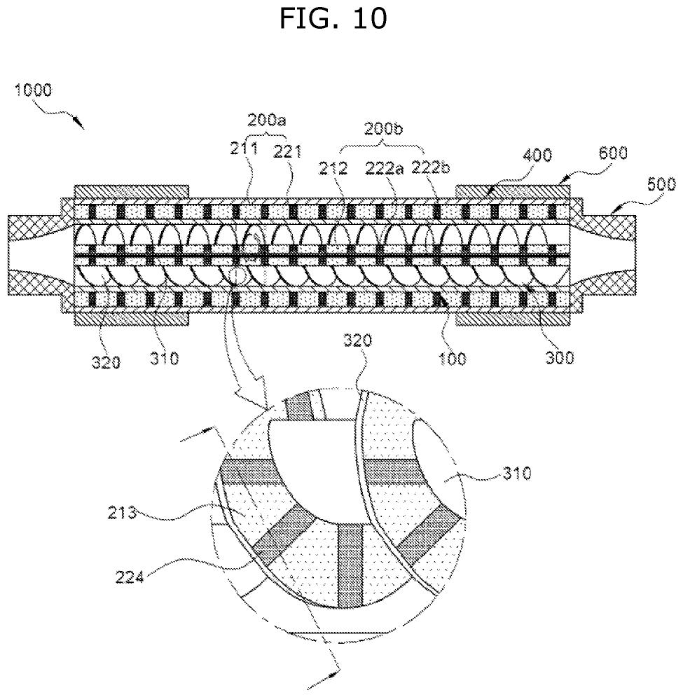

FIGS. 9 and 10 are cross-sectional views showing a water magnetizing device according to a fifth embodiment of the present disclosure. Referring to FIGS. 9 and 10, the water magnetizing device 1000 according to the fifth embodiment of the present disclosure may be formed such that the rotation pressure unit 300 is provided over the entire region in the axial direction of the water activation pipe 100. At this time, the magnetic material 200 is formed so as to surround the entire surface of the outer peripheral surface of the water activation pipe 100, and the water flown into the water activation pipe 100 is placed in the magnetic field until it is discharged, thereby being able to alleviate the deterioration of the atomization performance of water according to the flow velocity increased due to the rotation pressure unit 300. At this time, as the flow velocity of the inflowing water increases, the magnetic material 200 can use a permanent magnet 210 having a stronger magnetic force to alleviate the degradation of the atomization performance, but the method of using a permanent magnet with higher magnetic force has disadvantages that it is more difficult to handle the permanent magnet, and the overall cost of the product may increase. Further, there is a limitation in that it is difficult to expect a remarkable effect of the atomization performance due to an increase in magnetic force. Accordingly, as shown in FIG. 9, the water magnetizing device 1000 of the present disclosure is formed in a double structure which comprises an external magnetic material 200a provided on the outer peripheral surface of the sliding pipe 100 and an internal magnetic material 200b arranged inside the shaft 310 of the rotation pressure unit 300, thereby reducing the gap of the magnetic field region between the external magnetic material 200a and the internal magnetic material 200b, and further increasing the effect of the magnetic field acting on the flowing water. As a result, it is possible to alleviate the deterioration of the atomization performance due to the increase in the flow velocity by the rotation pressure unit 300.

More specifically, the magnetic material 200 comprises an exterior magnetic material 200a including a plurality of first permanent magnets 211 arranged so as to surround the outer peripheral surface of the water activation pipe 100, and a plurality of first shielding members 221 provided between the plurality of first permanent magnets 211, and an internal magnetic material 200b including a second permanent magnet 212 arranged so as to surround the inner peripheral surface of the shaft 310 of the rotation pressure unit 300 and provided at a position corresponding to the plurality of first permanent magnets 211, and a second shielding member 222 provided between the plurality of second permanent magnets 212.

At this time, the second shielding member 222 comprises a plurality of terminal shielding members 222a provided between the plurality of second permanent magnets 212 arranged in the axial direction and a transverse shielding member 222b provided so as to surround the inner peripheral surface of the plurality of second permanent magnets 212, thereby preventing the magnetic field from interfering with the inside of the second permanent magnet 212, and preferably, forming a magnetic field region between the first permanent magnet 211 of the adjacent external magnetic material 200a and the second permanent magnet 212 of the internal magnetic material 200b.

In addition, the magnetic material 200 further comprises a plurality of third permanent magnets 213 disposed along the outer surface of the rotation induction blade 320 of the rotation pressure unit 300, and a third shielding member 224 provided between the plurality of third permanent magnets 213. Therefore, the magnetic field region, which is formed in the axial direction by the third permanent magnet 213 provided between the adjacent rotation induction blades 320, is applied to the nano water flowing along the rotation induction blades 320, thereby increasing the flow complexity by the magnetic field applied to the water passing through the water activation pipe 100,and further increasing the atomization performance of water.

It goes without saying that the present invention is not limited to the above-mentioned embodiments, and various modifications may be made without departing from the gist of the present disclosure as claimed in the appended claims.

### EXPLANATION OF SYMBOLS

10: water pipe

11: water pipe connecting unit

1000: water magnetizing device

100: water activation pipe

110: water intake part

120: drainage unit

130: magnetizing unit

140: rotation induction projection

150: partition wall

200: magnetic material

200a: external magnetic material

220b: internal magnetic material

210: permanent magnet

211: first permanent magnet

212: second permanent magnet

213: third permanent magnet

220: shielding member

221: first shielding member

222: second shielding member

222a: terminal shielding member

222b: crossing shielding member

224: third shielding member

300: rotary pressure unit

310: shaft

320: rotation induction blade

400: housing

500: connection unit

600: protective cap

What is claimed is:

1. A water magnetizing device which is installed in a water pipe and which that atomizes and discharges water flowing into a magnetic field region formed inside, the water magnetizing device comprising:
a water activation pipe that forms a water channel through which water flows inside and includes a water intake unit through which water flows into one side of the axial direction, and a drainage unit through which water flows into the other side and atomized water is discharged;
a housing formed so as to surround the outer surface of the water activation pipe;
a magnetic material which is interposed between the water activation pipe and the housing and which includes a plurality of permanent magnets arranged so as to surround the outer peripheral surface of the water activation pipe and a plurality of shielding members provided between the plurality of permanent magnets; and
a rotary pressure unit including a shaft fixed in the axial direction inside the water activation pipe and a rotation induction blade formed spirally along the outer peripheral surface of the shaft,
wherein water passes through the magnetic field formed inside the water activation pipe by the magnetic material, and atomized water flows along the rotation induction blade of the rotary pressure unit, so that the water is discharged by having torque applied.

2. The water magnetizing device according to claim 1 wherein:
the magnetic material is arranged such that the plurality of permanent magnets and the plurality of shielding members alternate with each other in the axial direction of the water activation pipe, and the permanent magnets facing each other in the radial direction are arranged so as to have the same polarity.

3. The water magnetizing device according to claim 2, wherein:
the magnetic material is arranged such that the plurality of permanent magnets and the plurality of shielding members alternate with each other along an outer peripheral surface of the water activation pipe in a radial direction of the water activation pipe.

4. The water magnetizing device according to claim 1 wherein:
the water activation pipe is formed so that the inner diameter of the drainage unit becomes gradually smaller toward the outside in the axial direction, thereby increasing the torque of discharged water.

5. The water magnetizing device according to claim 1 wherein:
the water activation pipe further comprises a rotation induction projection formed so as to spirally protrude along the axial direction on the inner peripheral surface.

6. The water magnetizing device according to claim 5, wherein:
the water activation pipe further comprises a magnetizing unit in which the magnetic material is arranged on an outer peripheral surface and a magnetic field region is formed therein,
the rotation induction projection formed in the magnetizing unit of the water activation pipe is divided in the axial direction and formed so as to have a plurality of patterns, and the plurality of the divided rotation induction projections have different patterns from other adjacent rotation induction projections.

7. The water magnetizing device according to claim 1 wherein:
the water activation pipe further comprises a magnetizing unit in which the magnetic material is arranged on an outer peripheral surface to form a magnetic field region therein,
the magnetizing unit of the water activation pipe forms a plurality of partition walls projecting radially from the inner surface, the plurality of partition walls being formed so that the inner surfaces in contact with another adjacent partition wall in the axial direction face each other, and
the partition wall is formed so that a surface in contact with the inner surface of the water activation pipe corresponds to a position where the shielding member of the magnetic material is provided.

8. The water magnetizing device according to claim 1 wherein:
the rotary pressure unit is provided over the entire area in the axial direction of the water activation pipe,
the magnetic material comprises:
an external magnetic material comprising a plurality of first permanent magnets arranged so as to surround the outer peripheral surface of the water activation pipe, and a plurality of shielding members provided between the plurality of first permanent magnets; and
an internal magnetic material comprising a second permanent magnet arranged so as to surround an inner peripheral surface of the shaft of the rotary pressure unit, and is provided at a position corresponding to the plurality of first permanent magnets, and a second shielding member provided between the plurality of second permanent magnets.

9. The water magnetizing device according to claim 8, wherein:
the second shielding member of the internal magnetic material further comprises a plurality of terminal shielding members provided between the plurality of second permanent magnets arranged in the axial direction; and a crossing shielding member provided so as to surround the inner peripheral surface of the plurality of second permanent magnets.

10. The water magnetizing device according to claim 9, wherein:
the magnetic material further comprises a plurality of third permanent magnets arranged along the outer surface of the induction blade of the rotary pressing unit, and a third shielding member provided between the plurality of third permanent magnets.
